(19) United States
(12) Patent Application Publication
(10) Pub. No.: US 2024/0260776 A1
(43) Pub. Date: Aug. 8, 2024

(54) COOKWARE MADE OF SINTERED HIGH-PERFORMANCE MATERIAL AND METHOD FOR ITS PRODUCTION

(71) Applicant: Fritz Wiehofsky, Augsburg (DE)

(72) Inventor: Fritz Wiehofsky, Augsburg (DE)

(21) Appl. No.: 18/565,906

(22) PCT Filed: Dec. 20, 2022
(86) PCT No.: PCT/EP2022/086984

§ 371 Date: Nov. 30, 2023

(30) Foreign Application Priority Data
Jan. 8, 2022 (DE) 10 2022 000 067.9

(51) Int. Cl. A47J 27/00; A47J 36/02; A47J 36/04; C04B 35/573; C04B 41/00; C04B 41/51; C04B 41/86; C04B 41/88; C04B 111/00

(52) U.S. Cl. CPC A47J 27/002; A47J 36/025; A47J 36/04; C04B 35/573; C04B 41/009; C04B 41/51; C04B 41/86; C04B 41/88; C04B 2111/00965; C04B 2235/3826; C04B 2235/427; C04B 2235/5248; C04B 2235/6022; C04B 2235/9607; C04B 2235/963

(57) ABSTRACT

A method for manufacturing frying, grilling, baking, and/or cooking utensils involves creating a green body from powdery silicon carbide, carbon, fillers, binders, and additives using ceramic shaping methods such as pressing, isostatic pressing, hot pressing, casting, die casting, or injection molding. The green body is carbonized and subsequently infiltrated with a metallic silicon melt. Through a final infiltration firing, the green body, together with carbon, forms a silicon carbide bonding matrix, resulting in a dimensionally stable frying, grilling, baking, and/or cooking utensil of the highest stability without residual porosity and with a temperature resistance of up to 1,350° C. This method gives rise to the aforementioned cookware, produced through the described process.

### FIELD OF THE INVENTION

The invention relates to a method for the production of frying, grilling, baking, and/or cooking utensils, hereinafter also referred to as FGBC and the FGBC itself.

### STATE OF THE ART AND ITS DISADVANTAGES

Materials and material combinations used for FGBC nowadays include various metals and their alloys, ceramics, porcelain, clay, glass, silicone, but each only partially meets the complex requirements. Every known FGBC to date must make compromises. By way of example, common pans can be mentioned:

PTFE (“Teflon”) coated pan, a significant advantage being non-stick properties, but:
Limited temperature range
Problematic release of substances when overheated
Sensitive coating under mechanical stress
Often deforms when heated: energy transfer and flatness are problematic
Vulnerable to thermal shock
Limited lifespan of the coating

Ceramic coated pan, a significant advantage being non-stick properties, but:
Limited temperature range
Limited lifespan of the coating
Often deforms when heated: energy transfer and flatness are problematic
Vulnerable to thermal shock
Sensitive to oils with low smoke points—risk of resinification through polymerization

Enamel Coated Pan, Key Advantage Heat Resistance, but:
Limited non-stick properties
Susceptible to impact
Surface resistance only to a certain extent
Heavy
Vulnerable to thermal shock

Stainless Steel Pan, Key Advantage Heat Resistance, but:
Poor heat conduction
Limited non-stick properties
Often deforms when heated: energy transfer and flatness are problematic
Persistent deformation risk with thermal shock
Problematic for allergy sufferers
Acid-sensitive
Salt-sensitive

Wrought Iron Pan, Key Advantage Heat Resistance, but:
Seasoning required
Not flavor-neutral: problematic with changing ingredients
Poor heat conduction
Prone to warping
Acid-sensitive
Susceptible to rust and requires intensive care

Cast Iron Pan, Key Advantages Heat Resistance, Heat Retention, but:
Seasoning required
Not flavor-neutral: problematic with changing ingredients
Poor heat conduction
Heavy
Acid-sensitive
Susceptible to rust and requires intensive care
Vulnerable to thermal shock

Copper Pan, Key Advantage Reactivity, but:
Very expensive
Requires intensive care
Prone to deformation
Ideally suitable for gas stoves only
Interior coating susceptible to acid and mechanical impacts, depending on the realization.

Thus, the agony of choice remains, and only the application of various versions has so far fulfilled all purposes. This can be applied to other common FGBCs as needed. Depending on individual requirements, more extensive or very extensive equipment is necessary.

Especially high heat imposes special requirements on material and execution.

Coated FGBC which is most widely used nowadays is limited according to the limits as mentioned before. Primarily the lifespan of the coatings is limited.

Conversely, uncoated FGBC, with its inherently poor non-stick properties, is not a suitable choice for low and medium heat ranges as due to the material it is less controllable, requires more fat, and is often unwieldy and heavy.

Thin-walled and quickly adjustable ones are more prone to warping.

In addition physical and technological properties such as density, heat conductivity and temperature conductivity, heat capacity, thermal expansion, temperature change resistance, indeed influence each other in opposing ways and affect robustness, durability, dimensional stability, flavor neutrality, biological safety, adhesion, etc., depending on the constructive focus.

Cleaning poses special challenges. Caution and special care are required for coated FGBCs. Dishwasher cleaning is generally not recommended. For example, bare iron and cast iron should be seasoned and not come into contact with cleaning agents after forming a patina.

Overheating and burnt residues can render coated FGBC unusable, and uncoated FGBC typically requires extensive cleaning procedures and, if necessary, re-seasoning.

Whether it's a pan, pot, roaster, etc.—no FGBC has so far been equally suitable for all purposes and temperature ranges or has comprehensively fulfilled all desired properties.

The disadvantages cannot be eliminated with the materials used so far and could only be reduced with more or less effort.

Thus, the construction of the bottoms of frying and cooking utensils is often multi-layered to counteract warping and achieve better heat transfer and higher heat capacity. Aluminum alloys, copper, and stainless steel are generally combined, limiting individual properties depending on the execution.

Depending on the manufacturer, material, and realisation of the FGBC, the price ranges for the products can be considerable.

The variety of types makes it difficult for the user to make the suitable choice. The higher the affinity for the overall cooking theme, the greater the need for specialized FGBC. Otherwise, compromises must be made.

Especially the indispensably required high heat as well as the type and effect of heat conduction are the main decisive factors for the current variety of FGBC. Physical material properties can only be changed by using different materials or different material combinations. The properties achieved so far are considered exhausted.

Due to the sensitivity and vulnerability of non-stick coated FGBC, enormous amounts are disposed of annually. It often consists of various materials and frequently releases problematic substances during the thermal recycling process, which must be filtered according to regulations.

A method for producing silicon carbide ceramics by liquid or gas phase siliconization is known from DE 10 2013 114 628 A1 and EP 1 795 513 A1. A method for producing shaped bodies of silicon infiltrated, reaction-bonded silicon carbide is known from EP 0 134 254 A1.

### Objectives

Replacement of the various and diverse materials commonly used in the production of FGBC with a single technically and economically suitable material, involving the retention and expansion of the positive properties of all materials and material combinations used so far.

Substitution of PTFE (“Teflon”) and other non-stick coatings with a consistently homogeneous, non-stick material to effectively reduce the previously high waste volumes due to the limited lifespan of such coatings, as well as to avoid problematic waste products through thermal processing or recycling of FGBC bodies.

Replacement of mineral, fossil, and petrochemical raw materials by using recycled and renewable raw materials in the sense of a sustainable, CO2-reducing production.

### Objective of the Invention

The objective of the invention is to create a method for producing FGBC that replaces the various materials commonly used in FGBC production with a single suitable material while maintaining good non-stick properties.

### Solution

The above objective is achieved through the method for the production of frying, grilling, baking, and/or cooking utensils according to claim 1 and the frying, grilling, baking, and/or cooking utensils according to claim 7. Advantages of further developments are evident from the subclaims.

### DETAILED DESCRIPTION OF THE INVENTION

The decisive parameters for the applications of FGBC were qualified and quantified. As additional criteria for improving quality were defined, and exclusion criteria were determined. Candidate materials, material combinations, and material adaptations were specifically tested for their technical suitability, as well as their production and economic feasibility, with consideration of the potential market volume.

The combination of high, variably adjustable temperature, rapid and even temperature distribution, flat and consistent contact surfaces, non-stick effect with minimal or no oil or fat usage, easy handling, and practical long-term stability poses a particular material-technical challenge, especially due to recurring, temperature-intensive frying processes.

With BGBK with a non-stick coating, long-lasting functionality and a long service life are not compatible in everyday use due to the high temperatures often required. PTFE (“Teflon”), silicon oxide-based ceramics, diamond-like carbon layers (DLC=Diamond Like Carbon) generally have limited temperature and long-term stability as limiting factors.

For this reason, there are a number of wear-resistant, uncoated BGBK that are designed for high temperatures, but which in turn have disadvantages at low and medium temperatures, especially in terms of their non-stick properties.

The departure from previous development and process paths, focusing on optimizing materials specifically for non-stick properties, led to investigations and extensive practical tests with silicon carbide (SiC), specifically dense, highly heat-conductive silicon-infiltrated silicon carbide (SiSiC).

SiSiC, a ceramic material with high dimensional accuracy, generally consists of approximately 85-95% silicon carbide and correspondingly 15-5% metallic silicon. The finished material can be produced without pores, thus having a low specific surface area.

This is achieved by initially forming bodies from silicon carbide, carbon, carbon-containing fillers, carbonizable binders, and additives through known ceramic shaping processes, followed by pyrolysis. The resulting green bodies are then usually capillary infiltrated with molten metallic silicon at temperatures above 1,414° C.

The reaction between liquid silicon (Si) and carbon (C), possibly already present as silicon carbide, forms a SiC binding matrix, while the remaining silicon remains in unbound form, filling the pore spaces. This allows for the production of dimensionally stable, pore-free components with complex geometries, high dimensional accuracy, and heat conductivity, virtually free of shrinkage.

Alternatively, partially or completely biogenic silicon carbide-shaped parts can be produced through liquid siliconation of carbon-containing preforms, preferably based on renewable and/or recycled raw materials.

This involves mixing chopped, ground, or otherwise processed raw materials, such as wood, flax, hemp, peat, fruit pits, nutshells, etc., with carbonizable binders like furan, phenolic resin, sugar solution, wax emulsion, polyvinyl alcohol mixture, cellulose, starch, pitch, tar, etc. The mixture is then shaped and subsequently pyrolyzed.

Particularly suitable and cost-effective is the production of such preforms from carbon powder of plant origin obtained by slow high-temperature pyrolysis of biomass at temperatures up to approximately 1,000° C., followed by pulverization to a particle size ≤45 μm.

Such biomass carbonates have already undergone a complete pyrolysis/gasification process, with minimal remaining residues and a targeted high carbon content of ≥95%.

The otherwise high shrinkage during the pyrolysis of thermally untreated raw materials in the shaped bodies is anticipated, resulting in near-net-shape bodies with siliconation-friendly pore structure for subsequent melt infiltration at >1,414° C.

Activated carbon, which is additionally thermally definedly expanded through gas or chemical activation to achieve the largest possible surface area, has also proven to be suitable. Activated carbon is often further “refined” through (regenerable) loading, which would be disadvantageous for the underlying invention and is therefore omitted here.

The choice of unburdened raw materials, in addition to the applied production method, has a significant influence on the purity and quality of the molded parts to be pyrolyzed.

In terms of ecological production, preferred raw materials in Central Europe include forest management wood (especially beech and oak), industrial residual wood, uncontaminated old/used wood for obtaining carbon through pyrolysis to produce sustainable silicon-infiltrated silicon carbide products.

Plant-based raw materials such as fruit/olive pits, nutshells, and other types of wood, etc., are also usable, depending on the availability of production sites to avoid long transport distances.

In general, molded parts for the production of SiSiC-based FGBC can be realized with carbon powders/mixtures that are pure in terms of non-contamination and economically justifiable costs. Preference should be given to CO2-neutral or reducing products.

Regarding their extraction, for example, in the thermal splitting of methane into hydrogen and carbon, as well as other promising methods, various variants are usable for the production of FGBC.

If the raw material silicon is obtained from recycled material or based on renewable raw materials, the high process-related CO2 emissions from the energy-intensive production of metal-based FGBC can be effectively directed towards CO2 neutrality.

FGBC transforms from a resource-consuming to a resource-preserving, sustainable product.

Silicon carbide-based materials encompass various variants that find application as high-temperature-resistant technical ceramics. In this group, silicon-infiltrated silicon carbide (SiSiC) most closely meets the requirements of the invention.

SiSiC is used in thermal plant construction as a firing aid (beams, supports, rollers, etc.), as a burner component (flame tube, recuperator, jet tube), as a material for ballistic protective plates, as a bearing and sealing material for tribological applications, as a crucible, and others more.

Non-stick properties were neither a development goal nor an application criterion for the use of such industrial ceramics.

Pore-free, almost diamond-hard material and surface hardness (Vickers hardness HV10 18 . . . 22 GPa), high thermal conductivity (λ120 . . . 255 W/m·K)—with heat dissipation and exchange, not heating, being the focus of previous product developments with SiSiC—high temperature resistance (≤1,350° C.), and low thermal expansion (average linear expansion coefficient α20-400 3.6 . . . 4.1×10-6/K) initially fulfill basic technical requirements.

The density of 2.9-3.1 g/cm3 allows the production of FGBC elements with low weight and pleasant handling.

Particle sizes and distribution can be used to selectively influence the structure and specific properties of ceramic materials. Other control elements are fillers, binders, and sintering additives.

The production of FGBC falls within the ranges of previously applied material compositions.

SiSiC materials offer various options for adjusting and controlling desired properties, as comparisons of technical parameters of commercially available SiSiC ceramics show.

Good sliding properties are attributed to such technical ceramics, usually oriented towards tribologically defined applications (tribology: study of friction, wear, and lubrication between interacting surfaces in connection with material selection, surface treatment, coating, and topography).

Whether and to what extent good sliding properties, in combination with the absence of residual porosity and thus low specific surface area, also indicate advantageous non-stick properties of SiSiC-based FGBC could only be shown through practical tests due to the lack of empirical data.

For this purpose, starchy and protein-rich foods prone to strong adhesion when heated were sharply seared, fried, and cooked on SiSiC cooking surfaces with different surface structures, with minimal or no fat usage at various temperatures.

It was observed that an optimized, polished surface with a mean roughness Ra=0.4 μm compared to a surface “as fired” with an achievable mean roughness Ra≈1 μm did not exhibit higher practical utility in terms of non-stick behavior and cleaning.

The tested foods showed comparable results on both surfaces to FGBC equipped with non-stick coatings, with the advantage of being able to achieve more even browning and thus more intense roasting aromas with minimal, flavor-enhancing fat/oil usage. This is attributed to the very even, film-forming possibility of wetting the cooking surfaces.

In contrast, in non-stick coated pans, comprehensive wetting of the cooking surfaces is only possible with a large amount of layer-forming fat. Otherwise, fat and oil run together in droplets, making it difficult to achieve an even crust formation.

Initially, excessively high cooking temperatures for the respective food lead to sticking and burning residues with the new FGBC, which can be easily removed without additional cleaning agents, for example, using a stainless steel spiral cleaner without causing any damage to the surface.

If needed, cooking tables provide guidance on appropriate frying and cooking temperatures, as is customary. The temperatures of the inner bottom surfaces can be precisely measured using an infrared thermometer, allowing for quick adjustments.

Metal spatulas with sharp edges and thin blades, which can easily damage traditional non-stick coatings, facilitate the handling of stirring, flipping, and dividing the food with the new FGBC.

The flatness and non-stick properties of the inventive FGBC can therefore be defined solely through the use of finely crafted forming tools.

Unlike the usual and necessary extensive post-processing (grinding, honing, lapping, polishing), often the most expensive process in the production of technical ceramics, this is omitted for the use as FGBC, and the components can be economically manufactured “as fired.”

Unlimited availability of raw materials and adequate purchase prices allow for an economical, profit-oriented production and marketing given the existing market volume. Suitable production processes are known, sufficiently tested, and proven.

The combination of SiSiC with diamond particles in such composite bodies can enhance thermal conductivity, reduce thermal expansion, and increase wear resistance due to increased hardness.

This is advantageous for applications requiring a combination of superior properties, such as abrasion-resistant tools with intense heat dissipation, heat sinks with a low coefficient of expansion, inter alia. By selecting particle volume and sizes appropriately, parameters such as thermal conductivity, modulus of elasticity, and density can be controlled.

When designing BGBK with diamond particles, another increase in thermal conductivity above the values of copper cookware can be achieved while at the same time increasing edge strength:

modifications to “premium variants”, which, in industrial series production with large quantities, have higher purchase prices for synthetic diamond particles and the more technically complex Production processes that require their initial oxidation in air at >800° C. can be justified if there is sufficient economic profitability.

The use of the new material in the specified configuration range allows for a significant reduction in the wide variety of FGBC variants resulting from the diverse properties and preparation methods of our foods.

Furthermore, product advantages can be generated, elevating application, handling, and cost-effectiveness to a new, hitherto unknown level. This does not target individual properties or the design of existing FGBC elements but creates an entirely new level that has been positively confirmed by thorough testing and practical trials.

Now, for example, delicate fish and egg dishes at low temperatures, poultry/vegetables at medium temperatures, steaks/seared dishes at high temperatures, and plancha-grilled food at the highest temperatures can be without limitation seared, fried, and/or (gently) cooked with the same FGBC variant without restrictions.

Similarly successful are applications as baking stones. From two, make one—thus, grill plates made of the new material are equally suitable for baking various types of dough.

Until now, clay/ceramic materials or baking steel with their specific disadvantages (poor heat conduction, susceptibility to cracking, warping, and complicated cleaning) have been used for this purpose.

Pot-shaped containers are equally suitable for searing, braising, boiling, baking, and low-temperature cooking.

FGBCs have a long development history, available today in various material forms. From clay and ceramic materials and those made of stone, they evolved to iron, bronze, and copper. Later, glass, steel, aluminum, as well as various alloys and non-stick coatings were introduced.

The preparation over an open fire gave way to the closed, fire-heated stove. This was followed by gas stoves, electric stoves with cast plates, electric stoves with radiant heating elements, and electric stoves with induction. Alongside the stove, the modern oven developed into its current, also combined forms—electric, gas, and steam-heated, as well as the microwave.

### Advantages of the Inventive Frying, Grilling, Baking, and Cooking Utensils

The invention according to the claims offers an unprecedented level for occasional and professional users alike. Tailored to the common applications of “frying, grilling, baking, cooking,” the new FGBC combines all features according to the claims of this patent:

With the inventive FGBC made of homogeneous material, all cooking temperatures, in practice 60-350° C. and heating and preheating temperatures up to <1,350° C., can be applied. Accidental overheating has no consequences. The previously necessary variety of types is greatly reduced.

The bottom of the new FGBC remains flat under all temperature conditions and therefore does not require a pre-formed concavity in the cold state to achieve approximate flatness in the warm to hot state.

The energy transfer of the market-dominant glass ceramic cooktops improves significantly, regardless of the additionally high thermal conductivity and excellent IR absorption of the FGBC.

The new FGBC thus perfects the heat transfer through flat contact, intensive heat conduction, and extremely high radiation absorption.

The flat contact between the glass ceramic cooktop and the new FGBC also reduces the risk of any overflowing food entering and burning into the glass surface.

For gas cooktops with an open flame, the high heat and temperature conductivity of the new FGBC, in coordination with its bottom thickness, contribute to a further improvement in the inherently good controllability of this heating method.

Internally, fat/oil on the flat FGBC bottom can be evenly distributed under all temperature conditions and does not run to the periphery or center due to warping.

The specific heat capacity—influencing the temperature drop of a frying surface with the application/addition of “cold” food—of the new FGBC can be controlled constructively by the material thickness of the bottom surface. The bottom mass influences reactivity or controllability through its density and thickness.

Bottom thicknesses of 5-12 mm, depending on preference for rapid controllability, e.g., wok ≥5 mm, or heat capacity, e.g., grill, baking plates ≤12 mm, prove to be practical. The high thermal and temperature conductivity, ensuring rapid temperature equalization, is beneficial in this regard.

The thinner non-stick coatings of currently available FGBCs become more sensitive the higher the temperature. Such coatings are vulnerable to damage from metal cooking tools such as scrapers, turners, and especially cutting utensils. In contrast, the new FGBC, with its nearly diamond-like hardness and pore-free surface, sets new standards for use, durability, and lifespan.

Complete insensitivity to high temperatures is complemented by a defined thermal shock resistance ΔT>350° C. Commercially used SiSiC ceramics have a range of ΔT from just below 200° C. to over 800° C.

Thus, there is no warping, damage, or material failure of the hot body and hot surface of the new FGBC due to liquid ingress and absorption, as in pouring, plancha grilling, or sudden exposure to cold water during cleaning.

Excellent non-stick properties at all temperature ranges, up to a maximum practical 350° C. on the frying surface, perfect the application of the new FGBC.

Cooking ingredients that are typically problematic to fry, such as fish, eggs, fried potatoes, pancakes, etc., behave on/in the new FGBC similarly to a non-stick coating. Therefore, the use of fat/oil can be correspondingly limited.

Often, a sparing brushing of the food and/or the frying surface is sufficient, or fat/oil can even be entirely omitted.

Seasoning does not occur on the frying surface even with accidentally applied excessive heat. Food can only start burning or burn.

Easy cleaning is thus among the additional outstanding advantages.

Residues on generally heavily soiled grillware or problematic deposits from accidentally, even severely burned food like milk, rice, or pudding can be easily and residue-free removed without the use of chemical cleaning agents, solely using a cooktop scraper/water and/or stainless steel spiral cleaner/water, possibly with the addition of a few drops of detergent-

The surface still maintains its pore-free nature and non-stick properties permanently and unaffected. Changing food has no influence on taste neutrality. As the new FGBC is absolutely corrosion-free, protective and other maintenance measures are unnecessary.

It is suitable for household and professional dishwasher cleaning without restrictions. It remains unreactive to acid attacks, eliminating unpleasant taste transfer, as possible with uncoated, metallic FGBC (cast iron, iron, aluminum, copper).

All foods can be cooked, enriched, and stored in the containers without hesitation. Common food fermentation and preservation methods are unlimitedly applicable.

It is also suitable for allergy sufferers without restrictions, as no allergy-triggering ions, as in nickel-alloyed stainless steel, can be released due to acid contact.

The sum of all properties results in perfect comfort, practicality, long-term quality, cost-effectiveness, and universal usability. Especially the seemingly comfortable coated non-stick FGBC must be replaced or recoated after some use, thus proving to be significantly more expensive over time.

FGBC for high-temperature applications has so far involved compromises in comfort and increased use of fats. The combined use of different variants increases costs, storage requirements, and the inventory of cooking tools. Additionally, knowledge of the properties is required to choose the suitable FGBC for a perfect result.

### Additional Design Features

The inventive FGBC is highly thermally conductive. Production-wise, handles can be easily integrated into the bodies using the same material. However, they would become uncomfortably hot during culinary use. Therefore, handles are preferably provided to which low-heat-absorbing/insulating handles can be attached, either fixed or interchangeable.

In the case of interchangeable handles, they can be varied as needed, for example, as a pan with a long handle, and then ready to serve with handles.

Such handles can be conveniently removable for oven and upper grill use, providing practical storage advantages

The variable solution also offers space-saving benefits in storage.

Additionally, the handle receptacles can be designed to hold lids, eliminating the need to place them on the countertop when removed from the cooking vessel. The integrated handle receptacles do not require fastening elements in the lateral cooking surface area, avoiding the usual, intrusive rivets or screw heads on the inner surfaces of the FGBC bodies.

Sintered SiSiC is gray-black. For coloration of the lateral outer surfaces of FGBC, they can be ceramic glazed or metallically coated through thermal spraying (cold gas, suspension spraying). Materials with low thermal conductivity and low emissivity reduce heat radiation from such coated surfaces.

Induction-compatible versions can also be executed through ferritic, possibly segmented coating of the outer FGBC bottom surfaces, e.g., by cold gas spraying.

High-performance ceramic based on SiSiC has, by nature, lower edge strength, quantitatively defined by the fracture toughness Klc=3.0 . . . 4.0 MPa m1/2.

This is considered in the construction and design of the new FGBC to avoid sharp edges, ends, and corners that can be affected by too harsh mechanical impact. These are rounded, providing additional benefits in design and use/cleaning.

Additionally, for increased fracture toughness, e.g., for more delicate FGBC versions, fibrous fillers, alternatively/in addition to the already mentioned use of synthetic diamond particles, can be added to or replace the base material.

Short-fibered, preferably ground carbon fibers/fiber mixtures based on polyacrylonitrile, rayon, pitch L<500 μm are suitable. The length(s) of the C-short fibers is (are) advantageously chosen so that a homogeneous mixture with the combined materials of the base material and isotropic properties, and higher impact resistance, can be formed.

At the end in defined configurations, the body stability of FGBC meets all practical requirements more than adequately and withstands the usual mechanical stresses without restrictions.

Another advantageous embodiment (AF) is as follows.

AF 1: Roasting, grilling, baking, and cooking utensils, hereinafter referred to as FGBC, characterized in that green bodies made of powdery silicon carbide, carbon, fillers, binders, and additives are first produced by known ceramic shaping methods, e.g., pressing, isostatic pressing, hot pressing, casting, die casting, injection molding.

FGBC is characterized in that the green bodies are carbonized and then infiltrated with a metallic silicon melt, which, with carbon, forms a silicon carbide bonding matrix through a final infiltration firing.

This results in an absolutely dimensionally stable FGBC of the highest stability without residual porosity and a temperature resistance of up to ≤1,350° C., exhibiting excellent non-stick properties over the entire practical temperature range, which extends to ≤350° C. on the frying surfaces

Other advantageous embodiments (AFs) are as follows.

AF 2: FGBC characterized in that, for production according to AF 1, raw materials based on recycled and/or biogenic, preferably renewable raw materials are used instead of mineral, fossil, or petrochemical raw materials.

AF 3: A common feature of the manufacturing processes is the use of surface-smooth molding tools, whereby the use of correspondingly precise molding tools can achieve average roughness values Ra≈1 μm.

FGBC is thus characterized in that after the infiltration firing, no customary, cost-intensive machining steps such as grinding, honing, lapping, polishing are required for final shaping, and it forms “as fired” finished components.

AF 4: FGBC characterized in that it is equally applicable to all common thermal cooking processes, either individually or in combination, such as:

Roasting, as: pan, wok, pan with shaped interior (Takoyaki, Poffertjes, and others)

Grilling, as: smooth/ribbed/structured grill, pan, rack, teppanyaki, plancha, hot stone

Baking, as: pizza, bread baking, crepe plate, baking, casserole dish cooking, as: pot/casserole, roaster/reine, tajine, Dutch oven/Potije

The aforementioned cooking methods also include deep-frying, roasting, smoking, braising, steaming, oven, low-temperature, microwave, pressure/steam cooking.

The heat transfer can occur through heat conduction, convection, as well as infrared and electromagnetic radiation.

AF 5: FGBC characterized in that it is extremely resistant and insensitive to mechanical stress, with material hardness in a customary range HV10 18 . . . 22 GPa freely configurable. The use of metallic kitchen tools, cutting tools, pot scrapers, and cleaners is universally recommended.

AF 6: FGBC characterized in that a multitude of properties is achieved with a single, homogeneous material, which previously could only be realized partially and through the use of different materials and their combinations. This has so far necessitated a variety of different materials and types in FGBC.

The material composition and design of the new FGBC are chosen so that, in addition to the properties mentioned under AFs 1-5, the following are always achieved:

$$Thermal and temperature conductivity λ > 150 W / m \cdot K$$

$$Temperature change resistance Δ T > 350 ° C .$$

AF 7: FGBC characterized in that, to achieve, prioritize, and optimize the properties mentioned in AF 1-6, quantity compositions, grain sizes/grain size distributions of the base materials, additives, additional and filler substances can be varied within known technical limits and using common and proven production methods.

AF 8: FGBC characterized in that, in combination with synthetic diamond particles, a highly thermally conductive composite FGBC can be produced, which also has increased edge strength and hardness.

AF 9: FGBC characterized in that, in combination with carbon fibers/fiber mixtures, wherein preferably recycled fiber material with a length L<500 μm is used, increased fracture toughness and thus edge strength are achieved.

AF 10: FGBC characterized in that the outer surfaces are provided with ceramic glazing or thermal spraying, preferably cold gas spraying, suspension spraying, optionally with functional as well metallic coatings.

1. A method for producing roasting, grilling, baking, and/or cooking utensils, comprising:
producing a green body made of powdery silicon carbide, carbon, fillers, binders, and additives using at least one ceramic shaping method selected from the group consisting of pressing, isostatic pressing, hot pressing, casting, die casting, and injection molding, and
carbonizing the green body and then carrying out an infiltration firing of the green body with a metallic silicon melt,
wherein the green body, with carbon, forms a silicon carbide bonding matrix through a final infiltration firing, resulting in dimensionally stable roasting, grilling, baking, and/or cooking utensils of a highest stability without residual porosity and having a temperature resistance of up to 1,350° C.

2. The method according to claim 1, comprising using raw materials for production which are based on recycled and/or biogenic and/or renewable raw materials

3. The method according to claim 1, wherein no final machining through grinding, honing, lapping, or polishing occurs after the infiltration firing.

4. The method according to claim 1, wherein, before the infiltration firing, carbon fibers and/or carbon fiber mixtures are added to the green body.

5. The method according to claim 1, comprising adding synthetic diamond particles to the green body before the infiltration firing.

6. The method according to claim 1, wherein the outer surfaces are provided with ceramic glazing or thermal spraying with functional and/or metallic coatings.

7. Roasting, grilling, baking, and/or cooking utensils produced according to the method according to claim 1, wherein the green body made of powdery silicon carbide, carbon, fillers, binders, and additives is produced by at least one ceramic shaping method selected from the group consisting of pressing, isostatic pressing, hot pressing, casting, die casting, and injection molding, and the green body is carbonized and then infiltrated with a metallic silicon melt, wherein the green body, with carbon, forms a silicon carbide bonding matrix through a final infiltration firing.

8. The roasting, grilling, baking, and/or cooking utensils according to claim 7, wherein the roasting, grilling, baking, and/or cooking utensils have a material hardness HV10 with 18 to 22 GPa.

9. The roasting, grilling, baking, and/or cooking utensils according to claim 7, wherein the roasting, grilling, baking, and/or cooking utensils have a thermal and temperature conductivity λ of 120 to 255 W/m·K.

10. The roasting, grilling, baking, and/or cooking utensils according to claim 7, wherein a surface roughness of the roasting, grilling, baking, and/or cooking utensils has an average roughness value of Ra≈1 μm.

11. The roasting, grilling, baking, and/or cooking utensils according to claim 7, wherein the roasting, grilling, baking, and/or cooking utensils or the silicon carbide bonding matrix includes synthetic diamond particles.

12. The roasting, grilling, baking, and/or cooking utensils according to claim 7, wherein the roasting, grilling, baking, and/or cooking utensils or the silicon carbide bonding matrix includes carbon fibers and/or carbon fiber mixtures.

13. The roasting, grilling, baking, and/or cooking utensils according to claim 7, wherein the outer surface of the roasting, grilling, baking, and/or cooking utensils is provided with functional and/or metallic coatings.

14. The roasting, grilling, baking, and/or cooking utensils according to claim 7, wherein the roasting, grilling, baking, and/or cooking utensils are selected from the group consisting of: a pan, a wok, a pan with a shaped interior, a smooth/ribbed/structured grill, a pan, a rack, a teppanyaki, a plancha, a hot stone, a pizza, bread baking, and/or crepe plate, a baking and/or casserole dish, a pot, a casserole, a roaster, a reine, a tajine, a Dutch oven and a Potije.

15. The method according to claim 4, wherein the carbon fibers and/or carbon fiber mixtures contain recycled fiber material with a length L<500 μm.

16. The method according to claim 6, wherein the thermal spraying is cold gas spraying or suspension spraying.

17. The roasting, grilling, baking, and/or cooking utensils according to claim 12, wherein the carbon fibers and/or carbon fiber mixtures contain recycled fiber material with a length L<500 μm.
